(19) United States
(12) Patent Application Publication
(10) Pub. No.: US 2005/0090623 A9
(43) Pub. Date: Apr. 28, 2005

(54) Product based on rubber, such as a tire, and process for reducing the rolling resistance of the said tire

(76) Inventors: Salvatore Pagano, Chamalieres (FR); Lucette Dumergue, Rue Jean Achard (FR); Emmanuelle Averty, Herblay (FR)

Correspondence Address: MICHELIN NORTH AMERICA, INC., 515 MICHELIN ROAD, P.O. BOX 2026, GREENVILLE, SC, 29602, US

(21) Appl. No.: 10/007,601

(22) Filed: Dec. 5, 2001

Related U.S. Application Data
(63) Continuation-in-part of application No. 09/756,407, filed on Jan. 8, 2001, now Pat. No. 6,698,483.
Application No. 09/756,407 is a continuation of application No. PCT/EP00/03944, filed on May 3, 2000.

(30) Foreign Application Priority Data
Dec. 12, 2000 (FR) 00 16273
May 7, 1999 (FR) 99 05892

(51) Int. Cl. C08F 36/08

(52) U.S. Cl. 525/333.1; 152/525; 152/537

(57) ABSTRACT

The present invention concerns a product based on rubber, of the type comprising at least one buffer zone provided in order to trap oxygen external to the said product so as to protect from oxidation at least one sensitive zone of the said product, in which the said or each such buffer zone contains a composition based on at least one elastomer containing at least one salt of iron (III) provided to activate oxidation in the said composition, characterized in that the said salt is an iron (III) salt of an aromatic mono-carboxylic acid comprising one or more aromatic rings which may or may not be substituted. This product is obtained by incorporating the said salt by mechanical work into the elastomer or elastomers contained in the said composition for the said buffer zone. The invention is advantageously applied in a tire cover, and imparts improved rolling resistance.

### CROSS-REFERENCE TO RELATED APPLICATIONS

The present application claims priority to French Patent Application number FR00/16273 filed Dec. 12, 2000, naming as inventors Salvatore Pagano, Lucette Dumergue, and Emmanuelle Averty.

### FIELD OF THE INVENTION

The present invention concerns a product based on rubber, the process for obtaining it, and a process for reducing the rolling resistance of a tire made from the said product, such as a heavy-duty tire.

### BACKGROUND OF THE INVENTION

One of the main concerns of tire manufacturers is to increase the life of the tires. In particular, it is important to improve the endurance in relation to oxidising processes of the rubber compositions, the metallic or textile reinforcement and the interfaces between those mixes and reinforcements.

A known method of reducing these oxidation phenomena consists in restricting the amount of oxygen coming from the tire inflation air or from the atmosphere outside the tire, that gets to a zone of the tire cover that is particularly sensitive to oxidation. For a very long time this has been done with an internal calendering rubber formed as a layer of butyl rubber, which is impermeable to oxygen, applied on the inside wall of the tire covers. Unfortunately butyl rubber is not totally impermeable and the flow of oxygen into the body of the cover, though reduced, produces undesirable oxidation phenomena in the long term.

Other materials even more impermeable than butyl rubber have been proposed for the same purpose, as described for example in the documents U.S. Pat. Nos. 5,236,030, 4,874,670, 5,036,113, EP-A-337 279, U.S. Pat. Nos. 5,040,583 and 5,156,921. These materials, however, are expensive and their use in tire covers is associated with a number of problems.

Another way to avoid oxidation problems is to trap the oxygen chemically by the accelerated thermal oxidation of a rubber mix that acts as a buffer, located between a main source of oxygen and the zone to be protected against oxidation phenomena. For example, such a buffer composition may be located between the said internal calendering rubber layer and the carcass ply, to reduce the amount of oxygen that comes into contact with the said ply from the inflation air, especially in tire covers intended for fitting to heavy goods vehicles.

To accelerate the fixing of oxygen it is known to use in these buffer compositions a metallic salt that catalyses the oxidation, in particular a cobalt salt. The effect of the salt is to activate the homolytic decomposition of the hydroperoxides generated during the ageing brought about by the aforesaid oxidation phenomena. The salt is introduced into the buffer composition preferably in amounts of 0.2 to 0.3 parts by weight of cobalt equivalent per 100 parts by weight of the elastomer. This increases the amount of oxygen that can be trapped by the buffer composition by around 50 to 100% compared with the same composition containing no cobalt salt.

Unfortunately, experience shows that this improvement of the oxidation-related behaviour is accompanied by a substantial increase of the hysteresis losses of the buffer composition owing to the considerable quantity of cobalt salt introduced. This increase of the hysteresis losses leads on the one hand to self-heating of the composition and hence to shorter life, contrary to the purpose intended, and to an increase of the rolling resistance, which should also be avoided since manufacturers strive to limit the rolling resistance as much as possible in order to reduce fuel consumption.

For these reasons the use of buffer compositions, attractive as it may sound, has not developed as expected.

European patent document EP-A-507 207 describes a method for trapping oxygen by means of an elastomeric buffer composition contained in a wrapping layer. The buffer composition is characterised in particular by the presence of a transitional metal salt provided to activate the fixing of oxygen. As explained above, the metal salts described as preferred are cobalt salts. As subsidiaries, other metals such as manganese or even iron are also envisaged, but not in relation to specified salts.

The international patent documents WO-A-99/24502 and WO-A-00/68309 in the name of MICHELIN describe products based on rubber, such as tire envelopes, each being of the type that comprises at least one buffer zone provided in order to trap oxygen from outside the product so as to protect from oxidation at least one sensitive zone of the said product, the said or each such buffer zone containing a composition based on at least one elastomer that comprises at least one specific iron (II) salt which is provided in order to activate oxidation in the said composition. Each product is obtained by incorporating the said salt by mechanical work into the elastomer (s) contained in the said composition, to obtain the said buffer zone.

In document WO-A-99/24502 the said salt belongs to the group consisting of iron (III) acetylacetonate and the iron (III) salts of carboxylic acids having the formula Fe(CₙH₂ₙO₂)₃, in which n may be from 6 to 23.

In document WO-A-00/68309 the said salt is an iron (III) salt of a carboxylic acid having the formula Fe(CₙH₂ₙO₂)₃, in which n may be from 2 to 5.

The rubber-based products described in these two documents are such that the specific iron (III) salts they contain enable oxygen to be trapped within the buffer zone with sufficient effectiveness to protect the sensitive zone, or each such zone, against oxidation to a greater extent compared with the known buffer zones containing an oxidation activator, in particular based on a cobalt salt.

In addition, the products described in these two documents allow a significant reduction of the hysteresis losses in the buffer zone compared with the aforesaid known buffer zones, and this thanks to the choice of the said specific iron (III) salts. When the said products are tire envelopes, these show lower self-heating during rolling, and consequently longer life compared with tire envelopes characterised by the said known buffer zones.

### DETAILED DESCRIPTION OF THE INVENTION

Unexpectedly, the applicant has found that the aforementioned benefits obtained by virtue of the said iron (III) salts are substantially retained by using new iron (III) salts, also in order to obtain a rubber-based product of the type comprising at least one buffer zone provided in order to trap oxygen external to the said product so as to protect from oxidation at least one sensitive zone of the said product, the said or each such buffer zone containing a composition based on at least one elastomer which contains at least one specific iron (III) salt according to the invention to activate oxidation in the said composition.

The product according to the invention is such that the said salt is an iron (III) salt of an aromatic mono-carboxylic acid comprising one or more aromatic rings which may or may not be substituted, the said acid having one or other of the following general formulas: 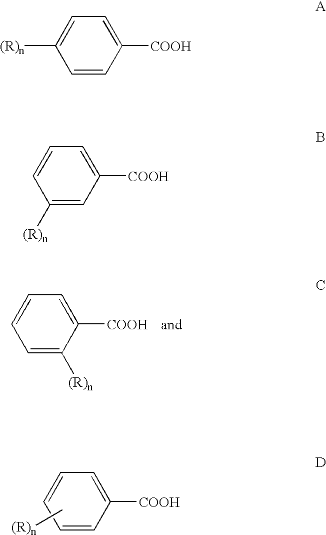
in which n is an integer which may be from 1 to 5, and:
in formulas A, B and C, R is a hydrogen atom, a substituted or unsubstituted alkyl group comprising from 1 to 8 carbon atoms, an alkoxyl group or a cyano group, and
in formula D, R is a substituted or unsubstituted aryl group comprising from 6 to 10 carbon atoms.

In one embodiment of the invention, the aromatic ring may be optionally substituted with a moiety selected from the group consisting of an alkyl group having from 1 to 8 carbon atoms, an alkoxy group, a cyano group, or an aryl group.

In one embodiment of the invention, the alkyl group may be substituted with an alkyl group having from 3 to 8 carbon atoms. In one embodiment of the invention, the alkyl group is an isopropyl alkyl group.

In one embodiment of the invention, the aryl group may be substituted by a methyl group. If, for example, the acid is 1-napthoic acid, the methyl group may be substituted at a position selected from the group of positions consisting of 2, 3, 4, 5, 6, 7, and 8. If for example, the acid is 2-napthoic acid, the methyl group may substituted at a position selected from the group of positions consisting of 1, 2, 4, 5, 6, 7, and 8.

According to one example embodiment of the invention, the said acid is a cyanobenzoic acid such as p-cyanobenzoic acid.

According to another example embodiment of the invention, the said acid is benzoic acid or an alkylbenzoic acid such as p-butylbenzoic acid.

According to another example embodiment of the invention, the said acid is a toluic acid such as p-toluic acid, m-toluic acid or o-toluic acid.

According to another example embodiment of the invention, the said acid is an alkoxybenzoic acid such as p-methoxybenzoic acid.

According to another example embodiment of the invention, the said acid is a naphthoic acid (with generic formula D), such as 1-naphthoic acid or 2-naphthoic acid.

If the said acid has the generic formula A, it is preferably p-cyanobenzoic acid, benzoic acid, a p-alkylbenzoic acid such as p-butylbenzoic acid, p-toluic acid, or a p-alkoxybenzoic acid such as p-methoxybenzoic acid.

If the said acid has the generic formula B, it is preferably m-toluic acid.

If the said acid has the generic formula C, it is preferably o-toluic acid.

Preferably, the quantity of the said iron (III) salt according to the invention present in the composition may range from about 0.01 to about 0.03 phr of equivalent iron, where the abbreviation “phr” means parts by weight per 100 parts by weight of the elastomer or totality of elastomers present in the composition. More preferably still, the quantity of iron (III) salt according to the invention ranges from about 0.01 to about 0.02 pbw of equivalent iron.

The composition according to the invention is based on natural or synthetic rubber, or a blend of two or more such rubbers. Examples of the synthetic rubbers suitable for use in the composition according to the invention are diene rubbers such as polyisoprene, polybutadiene, mono-olefin rubbers such as polychloroprene, polyisobutylene, the copolymers styrene-butadiene or styrene-butadiene-isoprene, the copolymers acrylonitrile-butadiene-styrene and the terpolymers ethylene-propylene-diene. Among the synthetic rubbers the diene rubbers are preferred, in particular any homopolymer obtained by polymerisation of a conjugated diene monomer having 4 to 12 carbon atoms, or any copolymer obtained by co-polymerisation of one or more dienes conjugated either between themselves or with one or more vinyl aromatic compounds having from 8 to 20 carbon atoms.

Suitable conjugated dienes are, in particular, 1,3-butadiene, 2-methyl-1,3-butadiene, 2,3-di(C1 to C5 alkyl)-1,3-butadienes such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, phenyl-1,3-butadiene, 1,3-pentadiene and 2,4-hexadiene.

Suitable vinyl aromatic compounds are, for example, styrene, ortho-, meta- and para-methylstyrene, the commercial mixture “vinyl-toluene”, para-tertbutylstyrene, the methoxy-styrenes, the chloro-styrenes, vinylmesitylene, divinyl benzene, vinyl naphthalene, etc.

The co-polymers may contain for example between 99% and 20% by weight of diene units and between 1% and 80% by weight of vinyl aromatic units.

The polymers may have any microstructure that is a function of the polymerisation conditions used, in particular the presence or absence of a modifying and/or randomising agent and the quantities of modifying and/or randomising agent used. The polymers may for example be block, statistical, sequenced or micro-sequenced polymers, etc., and may be prepared in a dispersion or in solution.

Preferred diene synthetic rubbers are the polybutadienes and in particular those having a content of 1,2-units between 4% and 80% and those having a content of cis-1,4 bonds of more than 90%, the polyisoprenes, butadiene-styrene co-polymers and in particular those having a styrene content between 5% and 50% by weight and more particularly between 20% and 40% by weight, a content of 1,2-bonds of the butadiene part between 4% and 65%, and a content of trans-1,4 bonds between 30% and 80%, these having a total aromatic compound content between 5% and 50% and a glass transition temperature (Tg) between 0° C. and −80° C., in particular those having a styrene content of between 25% and 30% by weight, a content of vinyl bonds of the butadiene part between 55% and 65%, a content of trans-1,4 bonds between 20% and 25% and a glass transition temperature between −20° C. and −30° C.

In the case of butadiene-styrene-isoprene co-polymers, the suitable ones are those having a styrene content between 5% and 50% by weight and more particularly between 10% and 40%, an isoprene content between 15% and 60% by weight and more particularly between 20% and 50% by weight, a butadiene content between 5% and 50% and more particularly between 20% and 40% by weight, a content of 1,2-units of the butadiene part between 4% and 85%, a content of trans-1,4 units of the butadiene part between 6% and 80%, a content of 1,2- plus 3,4-units of the isoprene part between 5% and 70%, and a content of trans-1,4 units of the isoprene part between 10% and 50%.

The synthetic rubbers may be coupled and/or starred or alternatively functionalised with a coupling and/or starring or functionalising agent.

These rubbers may be vulcanised and or cross-linked by any of the known agents, such as sulphur, the peroxides, the bismaleimides, etc.

The composition according to the invention contains the usual fillers and additives such as carbon black, silica or any other reinforcing white filler, stearic acid, reinforcing resins, zinc oxide, activators, pigments, vulcanisation accelerators or retarders, anti-ageing agents such as anti-oxidants, anti-reversion agents, oils or various agents to facilitate use, tackiness promoting resins, metal adhesion promoters, anti-ozone waxes, silicon binding and/or covering agents, etc.

The compositions according to the invention can be used in a wide variety of applications and in particular for numerous rubber products, for example in tire covers as buffer compositions between a source of oxygen, in particular inflation air or the external atmosphere and a zone to be protected in the tire cover. For example, these compositions may be used inside the internal calendering rubber, between this and the carcass ply, between the carcass ply and the crown plies, between the crown plies and the tread, between the carcass ply and the side walls, or even on the outside of the side walls.

A tire cover according to the invention, the said cover being of the type comprising internal calendering rubber, a carcass ply extending from one bead wire to the other, crown plies, side walls ending in beads comprising at least one bead wire, and a tread, is characterised in that the said or each such buffer zone containing the said composition occupies at least one of the following positions: radially inside the said internal calendering rubber, between the said internal calendering rubber and the said carcass ply, between the said carcass ply and the said crown plies, between the said crown plies and the said tread, between the said carcass ply and the said side walls, inside or outside the said side walls, and inside or outside the said tread.

It is particularly preferable for the said tire cover to be a heavy-duty tire cover in which the said or each buffer zone containing the composition according to the invention is located within a reinforcing elastomer layer provided between the said internal calendering rubber and the said carcass ply.

This reinforcing layer acts in particular to protect the carcass ply from aggressions such as the diffusion of oxygen so that the said ply will preserve its original characteristics for as long as possible, and consequently increases the life of the heavy-duty tire cover and if needs be the number of times it can be recapped.

The use of the iron compound according to the invention is very different from the known uses of iron compounds in the rubber industry, for example their known use as oxidising salts to promote the mastication of rubbers (peptising properties) or devulcanisation for recycling, these applications being described, for example, in the documents U.S. Pat. No. 3,324,100, EP-A-157 079 and RU-A-2 014 339.

As regards the process for obtaining a rubber-based product according to the present invention, this consists in incorporating the said iron (III) salt in the elastomer or elastomers contained in the buffer composition by working it in mechanically, to obtain the corresponding buffer zone.

According to another characteristic of the process, it consists in incorporating the said iron (III) salt in the said elastomer(s) at the same time as a filler intended to reinforce the said composition.

As regards the process according to the present invention for reducing the rolling resistance of a tire cover, this consists in incorporating an iron (III) salt as defined above in an elastomer or in the elastomers constituting the said tire cover, by working it in mechanically.

The invention will be easily understood with the help of the non-limiting examples given below.

These examples are either examples according to the invention, or ones not according to the invention that use compositions without any metallic derivative, or ones containing cobalt salts or even iron (III) salts that do not have the formula according to the invention specified earlier.

The oxidation-promoting efficacy of the iron or cobalt compounds is assessed by subjecting the compositions to ageing by thermal oxidation. The oxygen uptake is then measured by element analysis and the changes in mechanical properties such as the modulus, hysteresis loss and rupture properties are determined.

The tests are carried out under the following conditions:

Vulcanisation

Unless otherwise indicated, all the tests were carried out on specimens vulcanised by curing for 20 to 30 min at 150° C.

Ageing by Thermal Oxidation

A ventilated stove at 85° C. is used. This temperature is regarded as representative of the temperatures encountered during the operation of tire covers.

Hysteresis Loss

The hysteresis loss, or hysteresis (Ph) is measured by determining the energy lost at 60° C. on rebound compared with the energy put in, considering the sixth shock. The value, expressed as a percentage, is the difference between the energy supplied and the energy returned, referred to the energy supplied. The deformation for the losses measured is 40%.

Tensile Tests

These tests determine the elasticity stresses and rupture properties of the specimens tested. Unless otherwise indicated, they are carried out in accordance with the standard AFNOR-NFT-46002 of September 1988. During a second elongation (i.e. after one cycle for accommodation purposes) the nominal secant modules (or apparent stresses, in MPa) are determined at 10% strain (M10) and at 100% strain (M100). The rupture stress Cr (in MPa) and the elongation Ar at rupture (in %) are also measured. All these tensile measurements are carried out under normal temperature and humidity conditions, in accordance with the standard AFNOR-NFT-40101 (December 1979).

In the examples below, the following basic composition (in phr) is used, this being prepared in a way known as such by using an internal mixer and then an external mixer. All the figures indicated are parts by weight (phr), and it is specified that the iron (III) is introduced into the internal mixer, for example a Banburry, at the same time as the carbon black, the ZnO, the stearic acid and the 6PPD.

| | |
|---|---|
| Natural rubber | 100 |
| Carbon black N326 | 47 |
| Sulphur | 4.5 |
| DCBS | 0.8 |
| ZnO | 7.5 |
| Stearic acid | 0.9 |
| 6PPD | 1.5 |

in which:
DCBS: N,N-dicyclohexyl-2-benzothiazolesulphenamide
6PPD: N-1,3-dimethylbutyl-N′-phenyl-paraphenylene diamine.

Starting with this basic composition, the following compositions are prepared.

Control compositions:

Composition T1: basic composition with no metallic derivative.
Composition T2: basic composition containing in addition 0.25 phr of cobalt equivalent in the form of cobalt acetylacetonate.
Composition T3: basic composition containing in addition 0.02 phr of iron equivalent in the form of iron (III) acetylacetonate.
   Preferred Compositions According to the Invention
Composition I1: basic composition containing in addition 0.02 phr of iron equivalent in the form of iron (III) p-cyanobenzoate
Composition I2: basic composition containing in addition 0.02 phr of iron equivalent in the form of iron (III) p-butylbenzoate.
Composition I3: basic composition containing in addition 0.02 phr of iron equivalent in the form of iron (III) p-toluiate.
Composition I4: basic composition containing in addition 0.02 phr of iron equivalent in the form of iron (III) m-toluiate.
Composition I5: basic composition containing in addition 0.02 phr of iron equivalent in the form of iron (III) p-methoxybenzoate.
Composition I6: basic composition containing in addition 0.02 phr of iron equivalent in the form of iron (III) 2-naphthoate.
Composition I7: basic composition containing in addition 0.02 phr of iron equivalent in the form of iron (III) benzoate.
Composition I8: basic composition containing in addition 0.02 phr of iron equivalent in the form of iron (III) o-toluiate.
Composition I9: basic composition containing in addition 0.02 phr of iron equivalent in the form of iron (111) 1-naphthoate.

The iron (III) salts respectively included in compositions I1 to I9 according to the invention (salts of p-cyanobenzoic, p-butylbenzoic, p-toluic, m-toluic, p-methoxybenzoic, 2-naphthoic, benzoic, o-toluic and 1-naphthoic acids) were all synthesised as described below which, as an example, relates to the synthesis of m-toluic acid (the quantity of acid varying according to the acid used).

In a 250-ml Erlenmeyer flask, 15 g (or 0.11 mole) of m-toluic acid are mixed with 10 ml of water, with stirring. Using a dropping funnel, a previously prepared solution of sodium hydroxide (4.41 g or 0.11 mole of sodium hydroxide dissolved in 100 ml of water) are added a drop at a time. The solution is stirred for 20 min.

A solution of FeCl₃ (5.95 g or 0.037 mole dissolved in 100 ml of water) is added in a single addition. A precipitate forms and the suspension obtained is filtered and washed three times in 500 ml of water each time, to eliminate the sodium chloride formed.

This yields 15.7 g of the product which, after drying in a stove at 50° C. under vacuum, is obtained as a brown powder. Element analysis confirms the formation of the iron (III) salt of m-toluic acid.

As regards the aforementioned vulcanisation at 150° C. of each composition obtained, it should be noted that this lasted 20 min for the said control composition T2, but 30 min for the other compositions.

a) Using these compositions, the strain moduli M10 and M100 and the hysteresis losses were determined. The results are shown in Table 1.

TABLE 1

| | T1 | T2 | T3 | I1 | I2 | I3 | I4 | I5 | I6 | I7 | I8 | I9 |
|---|---|---|---|---|---|---|---|---|---|---|---|---|
| M10 | 4.5 | 5.9 | 4.6 | 4.5 | 4.7 | 4.7 | 4.7 | 4.7 | 4.7 | 4.6 | 4.1 | 4.2 |
| (MPa) | | | | | | | | | | | | |
| M100 | 2.2 | 2.6 | 2.3 | 2.2 | 2.3 | 2.3 | 2.3 | 2.3 | 2.3 | 2.3 | 2.1 | 2.1 |
| (MPa) | | | | | | | | | | | | |
| Ph | 17 | 21 | 18 | 17 | 18 | 17 | 18 | 18 | 18 | 17 | 16 | 16 |
| (%) | | | | | | | | | | | | |

Table 1 shows that the iron (III) salts of p-cyanobenzoic, p-butylbenzoic, p-toluic, m-toluic, p-methoxybenzoic, 2-naphthoic, benzoic, o-toluic and 1-naphthoic acids in the respective compositions I1 to I9 according to the invention, modify the characteristics of the basic composition less than does cobalt acetylacetonate in the control composition T2, and that the relative hysteresis loss of these compositions I1 to I9 is considerably lower than that of the said control composition T2.
b) Experiments were carried out to demonstrate the ability of compositions I1 to 19 according to the invention to fix oxygen after thermal oxidation for 2 weeks at 85° C., comparing it with the control compositions T1, T2 and T3.

The results of these thermal oxidation tests are shown in Table 2 below, which gives the percentage by weight of oxygen fixed.

TABLE 2

| | T1 | T2 | T3 | I1 | I2 | I3 | I4 | I5 | I6 | I7 | I8 | I9 |
|---|---|---|---|---|---|---|---|---|---|---|---|---|
| At | 1.2 | 1.6 | 1.8 | 1.7 | 1.8 | 1.7 | 1.7 | 1.6 | 1.7 | 1.8 | 1.6 | 1.5 |
| 85° C., | | | | | | | | | | | | |
| 2 weeks | | | | | | | | | | | | |

Table 2 shows that the iron (III) salt of p-cyanobenzoic, p-butylbenzoic, p-toluic, m-toluic, p-methoxybenzoic, 2-naphthoic, benzoic, o-toluic and 1-naphthoic acids enable composition I1 to I9 to fix an amount of oxygen that is essentially the same as or larger than that obtained with the control composition T2 containing cobalt acetylacetonate, the amount fixed being substantially larger compared with that of control composition T1 containing no iron or cobalt compound.

Basic compositions containing other metallic salts described as oxidation promoters in the literature, introduced in amounts such as to give an isomolar quantity of metal in relation to control composition T2, such as the salts of manganese (II) or (III) and in particular the carbonate, acetate or acetylacetonate of manganese (II), manganese (III) acetylacetonate, the salts of molybdenum (IV) and in particular molybdenum (IV) sulphide and oxide, the salts of copper (II) and in particular copper (II) hydroxide, carbonate, stearate, acetate or acetylacetonate, the salts of chromium (III) and in particular chromium acetylacetonate, and cerium (IV) sulphate, lead to results similar to those obtained with control composition T1 which contains no metallic salt.
c) Experiments were also carried out to determine the moduli and rupture properties and the hysteresis of compositions I1 to I9 according to the invention compared with the control compositions T1, T2 and T3, after applying to each composition the aforesaid treatment of ageing by thermal oxidation (at 85° C. for 2 weeks).

The results are given in Table 3 below, which shows, for each composition, the change in the values of the various parameters compared with those for the same composition before the thermal oxidation treatment.

TABLE 3
(* signifies that the specimen ruptured)

| | T1 | T2 | T3 | I1 | I2 | I3 | I4 | I5 | I6 | I7 | I8 | I9 |
|---|---|---|---|---|---|---|---|---|---|---|---|---|
| M10 | +59% | +74% | +109% | +274% | +86% | +88% | +73% | +68% | +68% | +67% | +51% | +50% |
| M100 | +138% | * | * | * | * | * | * | * | * | * | +95% | +100% |
| Ph | +30% | +45% | +67% | +45% | +40% | * | * | +31% | +38% | +41% | +50% | +56% |
| Ar | −78% | * | −92% | −89% | −90% | −90% | −89% | −88% | −90% | −90% | not | not |
| | | | | | | | | | | | meas- | meas- |
| | | | | | | | | | | | ured | ured |
| Cr | −71% | * | −86% | −86% | −85% | −86% | −85% | −83% | −85% | −81% | not | not |
| | | | | | | | | | | | meas- | meas- |
| | | | | | | | | | | | ured | ured |

In relation to the results of paragraph b) above, this Table 3 shows that the compositions I1 to I9 according to the invention shows an ability to fix oxygen which is distinctly better compared with the said known composition T2, whereas following the treatment by thermal oxidation, they show mechanical elongation and rupture properties which have evolved almost analogously after the thermal oxidation treatment.

1. Product comprising rubber, wherein the product comprises at least one buffer zone and at least one sensitive zone, wherein said buffer zone is provided in order to trap oxygen external to said product so as to protect from oxidation said sensitive zone of the said product, wherein said buffer zone contains a basic composition comprising at least one elastomer containing at least one iron (III) salt provided to activate oxidation in said composition,
wherein
said salt is an iron (III) salt of an aromatic mono-carboxylic acid, said acid comprising one or more aromatic rings which may be optionally substituted, and having one of the following formulas: 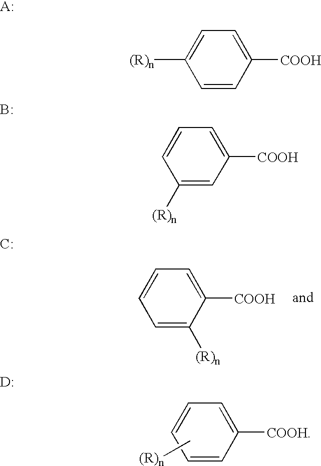
in which n is an integer ranging from 2 to 5, and:
in formulas A, B and C, R is a hydrogen atom, an alkyl group having from 1 to 8 carbon atoms, which may be optionally substituted, an alkoxyl group or a cyano group, and
in formula D, R is an aryl group having from 6 to 10 carbon atoms which may be optionally substituted.

2. Product comprising rubber according to claim 1,
wherein
the acid is a cyanobenzoic acid.

3. Product comprising rubber according to claim 1,
wherein
the acid is selected from the group consisting of benzoic acid and alkylbenzoic acid.

4. Product comprising rubber according to claim 3,
wherein
the acid is a toluic acid.

5. Product comprising rubber according to claim 1,
wherein
the acid is an alkoxybenzoic acid.

6. Product comprising rubber according to claim 1,
wherein
the acid is a naphthoic acid.

7. Product comprising rubber according to claim 1,
wherein
the quantity of the said iron (III) salt in said composition ranges from about 0.01 to about 0.03 phr of iron equivalent.

8. Tire cover comprising a calendering rubber internal to a carcass ply that extends from one bead wire to the other, crown plies external to the carcass ply, side walls exterior to the carcass that end in beads comprising at least one bead wire, and a tread exterior to the crown plies, wherein the tire cover comprises the product of claim 1 or 2 or 3 or 4 or 5 or 6 or 7.

9. Tire cover according to claim 8 wherein said buffer zone containing said composition occupies at least one of the following positions selected from the group consisting of:
radially inside said internal calendering rubber, between said calendering rubber and said carcass ply, between said carcass ply and said crown plies, between said crown plies and said tread, between said carcass ply and said side walls, inside said side walls, outside said side walls, inside said tread, and outside said tread.

10. Tire cover according to claim 9 wherein said tire cover further comprises a heavy duty tire cover, and further comprises a reinforcing elastomer layer provided between said internal calendering rubber and said carcass ply, wherein said buffer zone containing said composition is located within said reinforcing elastomer layer.

11. Process for obtaining a product comprising rubber according to claim 1 or 2 or 3 or 4 or 5 or 6 or 7, comprising the step of incorporating by mechanical work said iron (III) salt into the elastomer contained in said composition, to obtain said buffer zone.

12. Process for obtaining a product comprising rubber according to claim 11, said product further comprising a reinforcing filler,
wherein the process further comprises the step of incorporating said iron (III) salt into said elastomer at the same time as a filler provided to reinforce the said composition.

13. Process for reducing the rolling resistance of a tire cover comprising the step of incorporating by mechanical work into an elastomer constituting said tire cover an iron (III) salt as defined in any of claim 1 or 2 or 3 or 4 or 5 or 6 or 7.

14. The product of claim 2, wherein the cyanobenzoic acid is p-cyanobenzoic acid.

15. The product of claim 3, wherein the alkylbenzoic acid is p-butylbenzoic acid.

16. The product of claim 4, wherein the toluic acid is selected from the group consisting of p-toluic, m-toluic or o-toluic acid.

17. The product of claim 5, wherein the alkoxybenzoic acid is methoxybenzoic acid.

18. The product of claim 1, wherein the aromatic ring is optionally substituted with a moiety selected from the group consisting of an alkyl group having from 1 to 8 carbon atoms, an alkoxy group, a cyano group, or an aryl group.

19. The product of claim 1, wherein the alkyl group may be substituted with an alkyl group having from 3 to 8 carbon atoms.

20. The product of claim 19, wherein the alkyl group is an isopropyl alkyl group.

21. The product of claim 1, wherein the aryl group may be substituted by a methyl group.

22. The product of claim 21, wherein the acid is 1-napthoic acid, and the methyl group is substituted at a position selected from the group of positions consisting of 2, 3, 4, 5, 6, 7, and 8.

23. The product of claim 21, wherein the acid is 2-napthoic acid, and the methyl group is substituted at a position selected from the group of positions consisting of 1, 2, 4, 5, 6, 7, and 8.
